(19) United States
(12) Patent Application Publication
(10) Pub. No.: US 2011/0118018 A1
(43) Pub. Date: May 19, 2011

(54) GAME DEVICE

(75) Inventor: Miho Toyoda, Tokyo (JP)

(73) Assignee: Konami Digital Entertainment Co., Ltd.

(21) Appl. No.: 13/003,187

(22) PCT Filed: Jul. 6, 2009
(86) PCT No.: PCT/JP2009/062287

§ 371 Date: Jan. 7, 2011

(30) Foreign Application Priority Data
Jul. 8, 2008 (JP) 2008-178504

(51) Int. Cl. A63B 69/00; A63F 13/00

(52) U.S. Cl. 463/31; 463/35; 463/36

(57) ABSTRACT

A game device has a display unit for displaying an image on a screen, a first stage to be stepped on by a first player and a second stage to be stepped on by a second player, the first stage and the second stage being provided in front of the screen and next to each other in a transverse direction. Furthermore, the game device has a first speaker for an R channel and a second speaker for an L channel in an upper portion of the left periphery of the screen, the first speaker and the second speaker being arranged next to each other in a longitudinal direction when viewed from a player who is on the first stage or the second stage, and has a third speaker for the L channel and a fourth speaker for the R channel in an upper portion of the right periphery of the screen, the third speaker and the fourth speaker being arranged next to each other in a longitudinal direction when viewed from the player.

### TECHNICAL FIELD

The present invention relates to a game device.

### BACKGROUND ART

There is disclosed in Patent Document 1 a game device for a dance game. This game device displays on a screen an image in which plural marks move to a predetermined location, each mark being correlated in one-to-many association to plural operation devices to be stepped on by a foot, and replays a song using a pair of speakers provided so as to sandwich this screen. The above operation devices are provided in front of the screen, so that a player will step on the operation devices while viewing an image and listening to a song.

On the other hand, there is known a game device for a dance game in which two players can simultaneously play. This game device is provided with a first operation device group for one of the players and a second operation device group for the other player. Both operation device groups are provided in front of the screen in a transverse direction. Each player steps on an operation device group for the player while looking at an image for respective players displayed on a part of the screen and listening to the song for both players.
Patent Document 1: Japanese Patent Application Laid-Open Publication No. 2001-161878

In a dance game, the sense of presence affects the motivation of players. The sense of presence is generally degraded when the sounds are poor. Therefore, stereophonic sounds are preferred to monophonic sounds. Because the game device of Patent Document 1 has a pair of speakers, this game device can be modified so as to output stereophonic sounds. We propose, by further modifying such a modified game device, a game device in which two players can simultaneously play a game. Hereinafter, this game device will be referred to as a “first game device”.

In the first game device, two players stand next to each other in a transverse direction. Therefore, focusing on one player, the distance to an L-channel speaker and the distance to an R-channel speaker are considerably different. Furthermore, in the first game device, because each player changes postures to step on an operation device, some or all of the sounds for a player from the speaker that is more distant from the player are sometimes blocked by the other player.

Thus, the first game device has a disadvantage in the sounds being inferior or sounds that are important for the progress of a game being inaudible. Accordingly, we further propose that the first game device be further modified so that an L-channel speaker and an R-channel speaker are adjacently arranged in a transverse direction at each of the two ends of the screen. For example, we assume that an L-channel speaker, an R-channel speaker, a screen, an L-channel speaker, and an R-channel speaker are arranged sequentially from left to right in the listed order. Hereinafter, this game device is referred to as a “second game device”.

In the second game device, the sounds from the L-channel speakers and the sounds from the R-channel speakers reach each of the two players reliably. However, because, for one player, the distance between the location of a sound source of an L channel that is the closest to the player and the location of a sound source of an R channel that is the closest to the player is small, the channel separation is degraded, and the sounds are inferior.

Furthermore, in the second game device, a first sound image space (LR) created by the two speakers to the left side of the screen and a second sound image space (LR) created by the two speakers to the right side of the screen, and a third sound image space (RL) created by the R-channel speaker to the left side of the screen and the L-channel speaker at the right side of the screen are obtained, but the sounds cancel each other in a space in which the first sound image space and the third sound image space overlap and in a space in which the second sound image space and the third sound image space overlap.

If there is such a space in which the sounds cancel each other, the audience around the game device would feel a sense of strangeness. Moreover, that there is such a space is problematic in a double-stage-mode play in which one player steps on the operation devices for two players. This is because, in the double-stage-mode play, a player makes large, transverse movements for stepping on the operation devices for two players, whereby the player enters a space in which the sounds are cancelled.

### DISCLOSURE OF INVENTION

The present invention has been made in view of the situations described above, and has, as an object, to provide a game device capable of continuously providing rich sound without depending on the posture and the location of a player.

Description will first be given of terms.

A “computer game” is a game in which a play is carried out using a computer. In a computer game, an action that affects the content of a play is limited by an operation of a computer used for implementing the play. A computer used for the implementation of a computer game is called a “game device”.

A place at which a game device is installed is called a “game venue (game place)”. Examples of a game place include a facility at which visitors use the installed game terminal by paying a fee (for example, a game arcade) and a residential household at which a game terminal is installed. In the former, a visitor in most cases will be a user of a game terminal and will be a player of a computer game; and in the latter, a resident in most cases will be a user of a game terminal and will be a player of a computer game. In the former, a game terminal that has a function of collecting fees from its user (a type of commercial-use game machine) is installed in most cases; and in the latter, a game terminal that does not have a function of collecting fees from its user (a type of household use game machine) is installed in most cases.

A “computer” is, from among apparatuses for processing data, one that has a memory for storing data and a processor for executing a computer program loaded in the memory. “Data” represents information in a form that is recognizable by a machine such as a computer. Examples of data include data electrically representing information, data magnetically representing information, and data optically representing information. The “information” is a generic term for an object of a process that can be represented by data. The “memory” is a device that readably stores data written therein. Examples of the memory include a semiconductor memory, a magnetic memory, and an optical memory. A “computer program” is, from among collections (for example, a code string) of data (code) representing instructions, one that indicates the procedure of a process. Examples of a computer program include a program for causing a computer to carry out a procedure of a computer game when the program is run by the computer. A “processor” is a device which is equipped with an instruction set and which executes a computer program by performing a process of executing instructions represented by data in the computer program in accordance with a procedure indicated by the computer program, the computer program being a collection of data representing instructions. Examples of a processor include a single CPU (Central Processing Unit) and a collection of plural CPUs.

Examples of a computer include a computer provided with an interface with the outside. Examples of an interface with the outside include: an input unit for inputting information or data from the outside and an output unit for outputting information or data to the outside. “To input” information is an activity of generating data representing the outside information by detection or measurement. Examples of the input unit include a sensor, a button, and a keyboard. “To output” information is to represent information represented by data in such a way that information can be perceived by a human. Examples of ways in which information can be perceived by a human include by light, by sound, and by vibration. Examples of outputting information by light include the displaying of images and the blinking of lights. Examples of outputting information by sound include emitting sounds by a speaker and driving a sound structure by a solenoid (for example, ringing a bell). Examples of outputting information by vibration include oscillation by an oscillator.

Description will next be given of the present invention.

The present invention provides a game device having a display unit for displaying an image in a display area; a first operation device for a first player and a second operation device for a second player, the first operation device and the second operation device being provided in front of the display area and next to each other in a transverse direction; a first speaker for an R (right) channel and a second speaker for an L (left) channel, the first speaker and the second speaker being provided next to each other in an upper portion of the left periphery of the display area, with one of the speakers being located above the other speaker; and a third speaker for the L channel and a fourth speaker for the R channel, the third speaker and the fourth speaker being provided next to each other in an upper portion of the right periphery of the display area, with one of the speakers being located above the other speaker.

In this game device, in a case in which the first player and the second player simultaneously play a computer game, the sounds from the first speaker for the R channel and sounds from the second speaker for the L channel reach a first player reliably, and the sounds from the first speaker for the R channel and sounds from the second speaker for the L channel reach a second player reliably. Also, in this game device, in a case in which only the first player plays a computer game, the sounds from the first speaker for the R channel and the sounds from the second speaker for the L channel reach the first player reliably. Therefore, according to this game device, it is possible to provide rich sounds without this being dependent on the posture and location of a player.

In this game device, a height of the first speaker from a floor surface and a height of the third speaker from the floor surface may be approximately the same, and a height of the second speaker from the floor surface and a height of the fourth speaker from the floor surface may be approximately the same. In this description, “approximately” means to allow for manufacturing errors. In this game device, because two L-channel speakers and two R-channel speakers are arranged diagonally, no problem will be caused by only one of the L-channel or R-channel sounds becoming louder for some players depending on the height of the player.

In each of the above modes of the game device, a line passing through the first speaker and the second speaker and a line passing through the third speaker and the fourth speaker may be inclined so that the distances to a vertical line in front of the display area become smaller as the lines extend upward. In this game device, the difference between the distance from the head of a player to the first speaker for the R channel and the distance to the second speaker for the L channel and the difference between the distance from the head of the player to the third speaker for the L channel and the distance to the fourth speaker for the R channel each will be reduced. Therefore, richer sounds can be provided.

In each of the above modes of game device, in the display area, a first image for the first player and a second image for the second player may be displayed next to each other in a transverse direction. According to this game device, because there is high probability of two players standing next to each other in a transverse direction, the probability is increased of each of the above effects being obtained. Furthermore, in each of the above modes of the game device, the first operation device and the second operation device each may be operation devices to be stepped on by a foot. In a computer game using operation devices having operation devices each to be stepped on by foot, because the body movements of a player are large, the effects of the present invention become even more pronounced.

### EFFECTS OF THE INVENTION

According to the present invention, it is possible to provide a game device capable of continuously providing rich sounds without depending on the posture and the location of a player.

### BRIEF DESCRIPTION OF THE DRAWINGS

FIG. 1 is a perspective view showing an external view of a game device according to an embodiment of the present invention.

FIG. 2 is a diagram showing an example of an image displayed on an image display device of the game device.

FIG. 3 is a diagram showing an example of an image displayed on the image display device of the game device.

FIG. 3A is a diagram showing an example of two images displayed on the image display device of the game device.

FIG. 4 is a block diagram showing an electrical configuration of the game device.

FIG. 5 is a diagram schematically showing a configuration of standard dance data used in the game device.

FIG. 6 is a flowchart showing a procedure of a game process performed by the game device.

FIG. 7 is a diagram schematically showing how the sounds are conveyed from speakers of the game device to a player (a single stage mode and 1-player mode).

FIG. 8 is a diagram schematically showing changes in how the sounds are conveyed from the speakers to a player (a single stage mode and 1-player mode).

FIG. 9 is a diagram schematically showing how the sounds are conveyed from speakers to players (a single stage mode and 2-player mode).

FIG. 10 is a diagram schematically showing how the sounds are conveyed from the speakers to a player (a double stage mode).

FIG. 11 is a diagram schematically showing changes in how the sounds are conveyed from the speakers to a player (the vertical direction in the double stage mode).

FIG. 12 is a diagram schematically showing changes in how the sounds are conveyed from the speakers to a player (the transverse direction in the double stage mode).

FIG. 13 is a perspective view showing an external view of a game device according to a modification of another embodiment.

### BEST MODE FOR CARRYING OUT THE INVENTION

In the following, description will be given of a preferred embodiment of the present invention with reference to the drawings. The specific configurations described below are merely examples, and the present invention encompasses various embodiments obtained by modifying the specific configurations within its scope. An embodiment of the present invention relates to a specific dance game. The specific dance game is a type of a computer game in which a player is evaluated to be better as the degree of agreement is higher of the player's steps with the standard dance prepared in advance. The number of standard dances prepared in advance is 2. However, this is merely to facilitate understanding of the description. Alternatively, one standard dance may be freely selected from a greater number of standard dances.

### Configuration

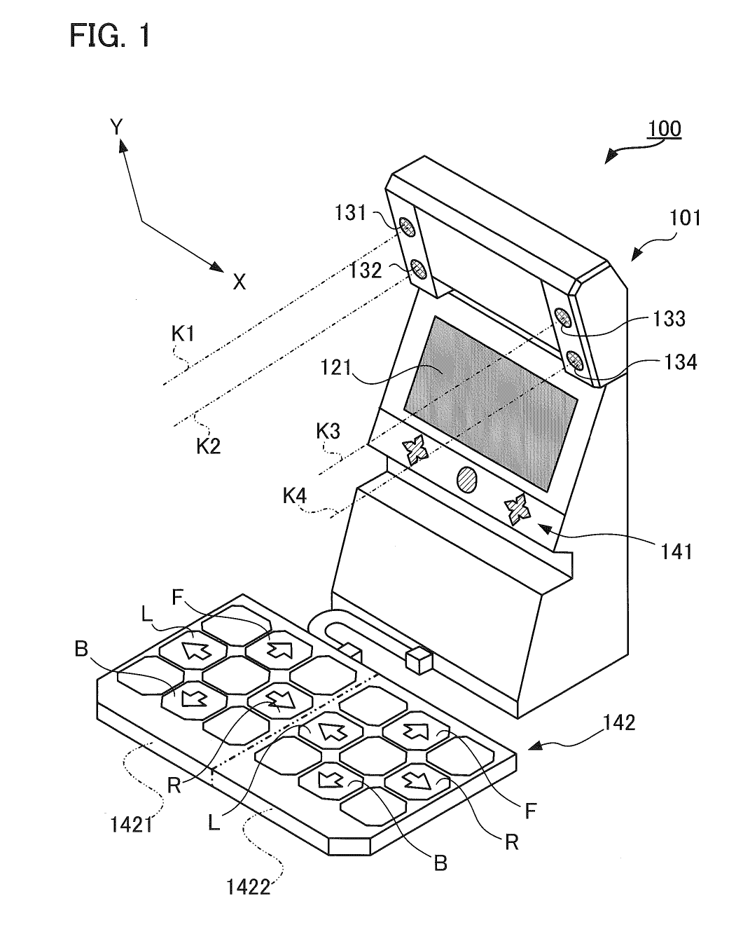

FIG. 1 is a perspective view showing an external view of a game device 100 according to an embodiment of the present invention. Game device 100 is a game device (commercial-use game machine) for a specific dance game, and is installed at a game venue. Game device 100 has a main body 101 and a tabular lower operation unit 142. The lower surface of lower operation unit 142 is in contact with the floor surface of the game venue, and a player can perform steps on lower operation unit 142. In the following description, “front”, “back”, left”, and “right” indicate the front, back, left, and right, respectively, for a player facing main body 101.

Lower operation unit 142 has a tabular, first stage 1421 for a first player and a tabular, second stage 1422 for a second player. First stage 1421 and second stage 1422 do not overlap each other, and the upper surfaces thereof are flush and form the upper surface of lower operation unit 142. Play modes of a specific dance game include a single stage mode and a double stage mode.

In the single stage mode, one player dances on each stage. The single stage mode includes a 1-player mode and a 2-player mode. In the 1-player mode, a player dances on first stage 1421, but no one dances on second stage 1422. In the 2-player mode, a first player dances on first stage 1421, while a second player dances on second stage 1422. Each player performs steps, with the center, approximately, of the using stage as a home position.

In the double stage mode, one player dances using first stage 1421 and second stage 1422. Therefore, one player performs steps, with the boundary, approximately, between first stage 1421 and second stage 1422 as a home position.

First stage 1421 and second stage 1422 each has a front step panel F that is stepped on when a player moves a leg of the player forward from the home position, a back step panel B that is stepped on when the player moves the leg backward, a left step panel L that is stepped on when the player moves the leg leftward, and a right step panel R that is stepped on when the player moves the leg rightward. Each panel of first stage 1421 corresponds to a first operation device and each panel of second stage 1422 corresponds to a second operation device. In each of first stage 1421 and second stage 1422, exposed on the upper surface thereof are front step panel F, back step panel B, left step panel L and right step panel R.

Main body 101 is connected to an edge of lower operation unit 142. Main body 101 is provided with a screen (display area) 121 on which color images are displayed, speakers 131 to 134 for outputting sounds, the speakers having identical specifications, and an upper operation unit 141 having an operation device (for example, a dial or keys) operated by a player. Screen 121 is a rectangular area which extends along a transverse direction (X direction) parallel to the floor surface, and the above-described first stage 1421 and second stage 1422 are located next to each other in a transverse direction in front of screen 121. Upper operation unit 141 generates data corresponding to an operation of the operation device of the upper operation unit, to supply the data to a processor of game device 100, and serves as an information input unit for inputting information from the outside.

A speaker (first speaker) 131 for an L (left) channel and a speaker (second speaker) 132 for an R (right) channel are provided next to each other in a Y-direction in the upper portion of the left-end side of screen 121. The height of speaker 131 from the floor surface is large and that of speaker 132 is small. A speaker (third speaker) 133 for the R channel and a speaker (fourth speaker) 134 for the L channel are provided next to each other in a Y-direction in the upper portion of the right-end side of screen 121. The height of speaker 133 from the floor surface is large and that of speaker 134 is small. In this description, the L channel and the R channel are not based on the locations of speakers. The L channel is a channel to which a signal for sound replay on the left side of a stereophonic system is transmitted, and the R channel is a channel to which a signal for sound replay on the right side of the stereophonic system is transmitted. An L-channel speaker is a speaker for emitting sounds based on a signal intrinsically aimed at the sound replay on the left side of the stereophonic system regardless of the location at which the speaker is mounted. Similarly, an R-channel speaker is a speaker for emitting sounds based on a signal intrinsically aimed at the sound replay on the right side of the stereophonic system regardless of the location at which the speaker is mounted.

The height of speaker 131 from the floor surface and the height of speaker 133 from the floor surface are approximately the same, and the height of speaker 132 from the floor surface and the height of speaker 134 from the floor surface are approximately the same. In other words, in game device 100, the L-channel speakers and the R-channel speakers are arranged diagonally. Additionally, provided that the height, from the floor surface, of the head of a player of a normal height standing on lower operation unit 142 is H and that the height, from the floor surface, of the head of a normal player who jumps the highest during a play is J, that the height, from the floor surface, of each speaker 131 and 133 is determined so that the height is approximately the same as H and, the height, from the floor surface, of each speaker 132 and 134 is determined so that the height is higher than J.

The Y direction is determined so that the location of a head of a player of a normal height standing on lower operation unit 142 is located above a plane including a normal line K2 of speaker 132 and a normal line K4 of speaker 134 and so that the location of a head of a player of a normal height who jumps the highest during a play on lower operation unit 142 is below a plane including a normal line K1 of speaker 131 and a normal line K3 of speaker 133. Therefore, the Y direction, a line passing through first speaker 131 and second speaker 132 and a line passing through third speaker 133 and fourth speaker 134 are inclined so that the distances to a vertical line in front of screen 121 become smaller as the lines extend upward, and the difference between the distance from the head of a player to speaker 131 and to speaker 132 and the difference between the distance from the head of a player to speaker 133 and to speaker 134 become smaller as the lines extend upward.

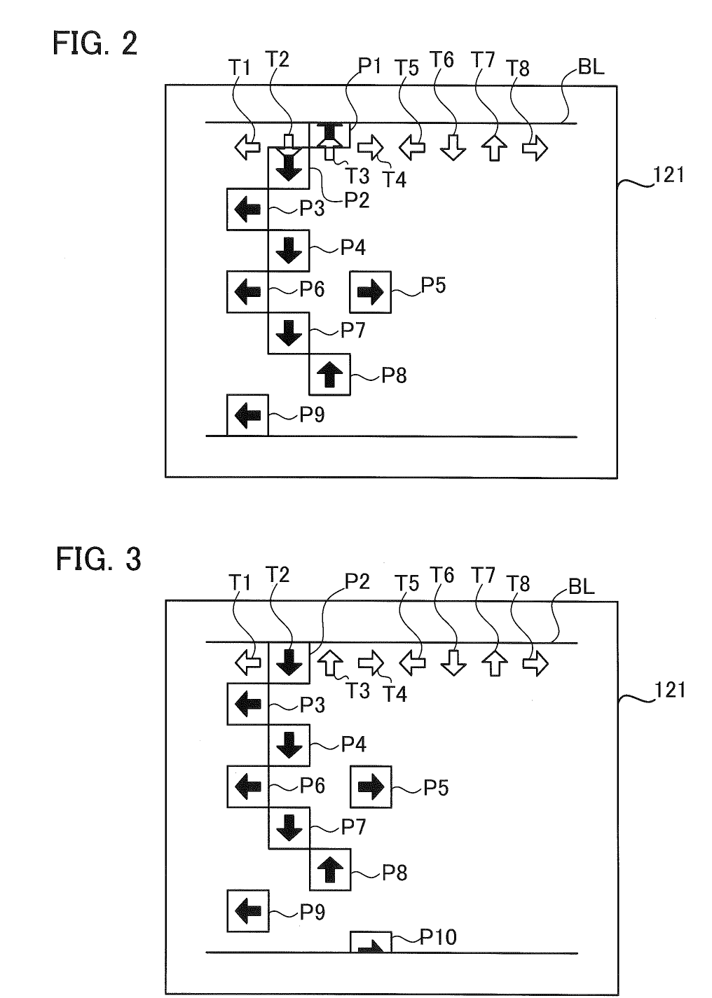

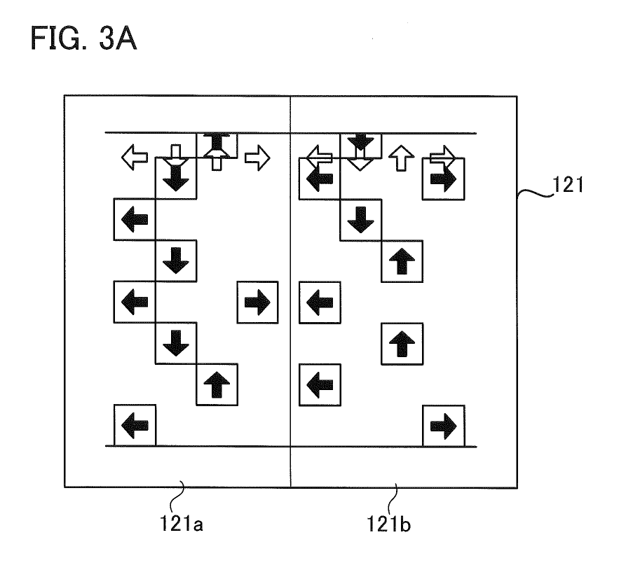

FIGS. 2 and 3 are diagrams each showing an example of an image displayed on screen 121. In the specific dance game, the image of FIG. 3 is displayed on screen 121 immediately after the image of FIG. 2 is displayed. As is clear from these figures, in the specific dance game, displayed on screen 121 are step panel instruction marks P1, P2, . . . moving from the lower to the upper portion of the screen, and displayed on the upper portion thereof are step time instruction marks T1 to T8 that are fixedly provided next to one another in the right-and-left direction.

Step time instruction marks T1, T2, T3, and T4 are marks for instructing a time to step on left step panel L, back step panel B, front step panel F, and right step panel R, respectively, of first stage 1421; and step time instruction marks T5, T6, T7, and T8 are marks for instructing a time to step on left step panel L, back step panel B, front step panel F, and right step panel R, respectively, of second stage 1422. Each of step panel instruction marks P1, P2, . . . instructs one of front step panel F, back step panel B, left step panel L, or right step panel R of first stage 1421 as a step panel to step on.

The images shown in FIGS. 2 and 3 are images of where the play mode is the 1-player mode of the single stage mode. In the case of the 2-player mode or the double stage mode, as shown in FIG. 3A, a first image 121a for a first player and a second image 121b for a second player are displayed next to each other in the transverse direction on screen 121. Specifically, first image 121a is displayed on the left half portion of screen 121, and second image 121b is displayed on the right half portion of display screen 121. First image 121a includes a step panel instruction mark for instructing each step panel of first stage 1421, and second image 121b includes a step panel instruction mark for instructing each step panel of second stage 1422. In the upper portion of screen 121, the front end of each step panel instruction mark reaches a base line BL, and the step panel instruction mark completely overlaps a step time instruction mark for the step panel at a time when a step panel instructed by the mark is to be stepped on.

In the specific dance game, a player stands on lower operation unit 142, and while listening to the sounds output from speakers 131 to 134 and looking at an image displayed on screen 121, steps on a step panel instructed by the image at a time instructed by the image and sound. Thus, in the play of a dance game, a player faces main body 101.

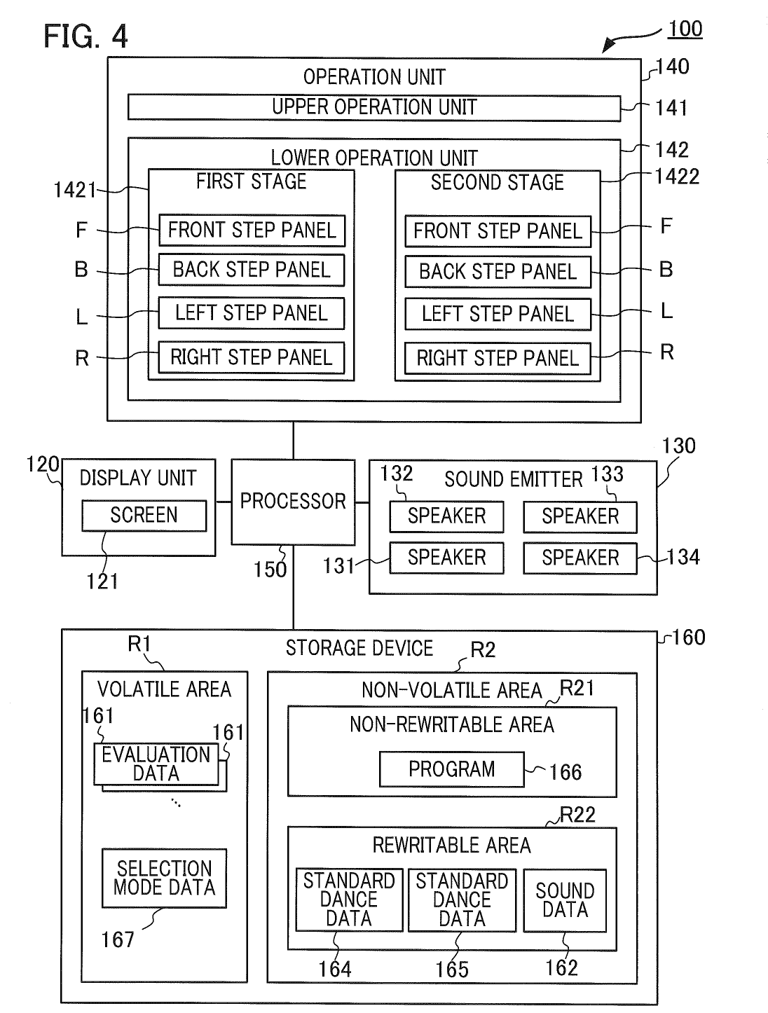

FIG. 4 is a block diagram showing an electric configuration of game device 100. Game device 100 has a processor 150 for performing various data processes, an operation unit 140 that is operated by a player and for supplying operation data corresponding to the operation to processor 150, a display unit 120 for displaying, on screen 121, an image using image data supplied from processor 150, a sound emitter 130 for outputting, from speakers 131 to 134, sound data from processor 150, and a storage device 160 for storing various types of data. Display unit 120 is, for example, a monitor but may be a video projector. In the case of a video projector, a screen on which an image is projected corresponds to screen 121.

Operation unit 140 has an upper operation unit 141 and a lower operation unit 142. Upper operation unit 141 supplies processor 150 with operation data corresponding to the content of an operation of the operation device. Therefore, upper operation unit 141 serves as an information input unit for inputting information from the outside. Front step panel F of first stage 1421 for lower operation unit 142 is provided with a switch (for example, a cable switch) for which ON or OFF can be switched depending on a load, and when the switch is stepped on by person, supplies processor 150 with operation data indicating an address of the front step panel F itself. This is the same for other step panels for first stage 1421, and also for front step panel F, back step panel B, left step panel L, and right step panel R for second stage 1422. Thus, first stage 1421 and second stage 1422 each serve as an operation unit for supplying processor 150 with operation data corresponding to the content of an operation of the operation device. Naturally, lower operation unit 142 serves as an operation unit for supplying processor 150 with operation data corresponding to the content of an operation by a person to the operation device.

A memory area of storage device 160 is divided into a volatile area R1 for which the power is required for retaining the memory and a non-volatile area R2 which is not. Non-volatile area R2 is divided into a non-rewritable area R21 in which the memory content is non-rewritable and a rewritable area R22 in which the memory content is rewritable. Volatile area R1 is made, for example, by a RAM (Random Access Memory), and non-rewritable area R21, for example, by a ROM (Read Only Memory) and rewritable area R22, for example, by a hard disk.

There is stored, in non-rewritable area R21, a computer program 166 executed by processor 150. Computer program 166 is a computer program for causing processor 150 of game device 100 to perform a game process described below. There are stored in rewritable area R22 standard dance data 164 and 165 indicating the content of a standard dance prepared in advance and sound data 162 for replaying the stereophonic sound corresponding to a standard dance. Standard dance data 164 shows the content of a standard dance in the single stage mode, and standard dance data 165 shows a standard dance in the double stage mode. Sound data 162 may be data generated by sampling or other data.

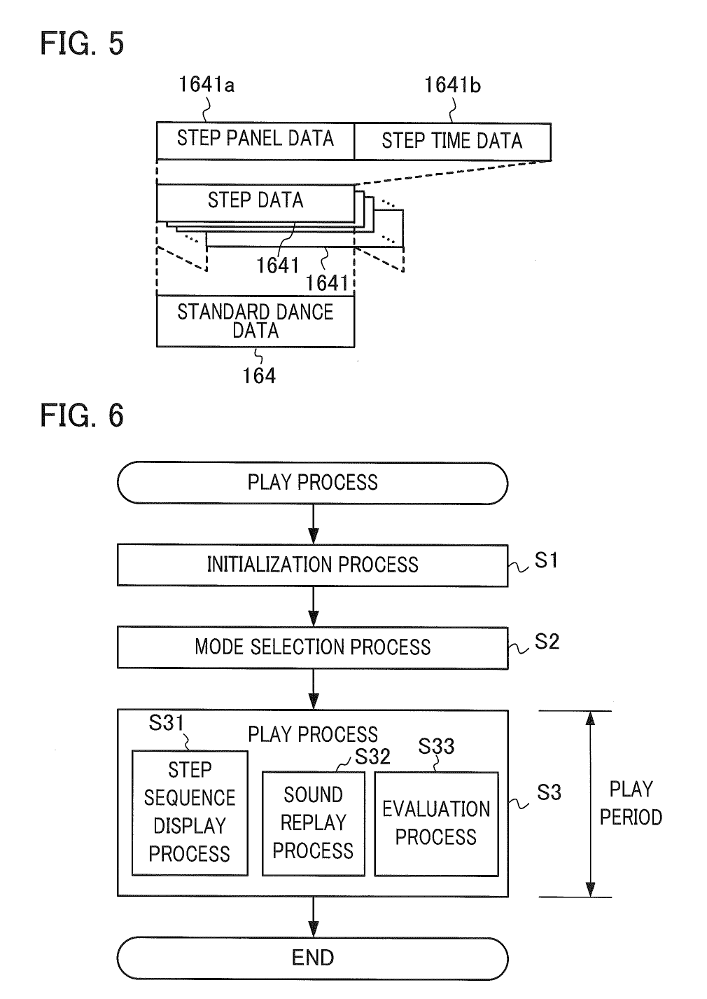

FIG. 5 is a diagram schematically showing a configuration of standard dance data 164. Standard dance data 164 shows the contents of a series of steps (step sequence) using a stage, and has plural pieces of step data 1641. Each step data 1641 is data showing details of one step, and has step panel data 1641a showing an address of a step panel to be stepped on for the step and step time data 1641b indicating a time for stepping the step.

Standard dance data 164 is for the single stage mode, and is used for each of two plays progressing in parallel in the 2-player mode. Therefore, the address indicated by the step panel data 1641a is a relative address indicating one of the four step panels in one stage used by a player, and the total number of the addresses is 4. A time indicated by time data 1641b is, for example, elapsed time from the start of the sound replay using sound data 162. The address indicated by step panel data included in standard dance data 165 is an absolute address indicating one of the eight panels of lower operation unit 142, and the total number of addresses is 8.

Selection mode data 167 is stored in volatile area R1 of FIG. 4. Selection mode data 167 is data showing a mode selected by a player, and indicates a combination of the single stage mode and the 1-player mode, a combination of the single stage mode and the 2-player mode, or the double stage mode.

In volatile area R1, plural pieces of evaluation data 161 are sequentially written for each play (player). Therefore, in a case in which the selected mode is the 1-player mode or the double stage mode, pieces of evaluation data 161 for one sequence are sequentially written in volatile area R1. In a case in which the selected mode is the 2-player mode, pieces of evaluation data 161 for two sequences are sequentially written in volatile area R1. Each evaluation data 161 indicates evaluation indicating the accuracy of a step (operation) by a player.

### Operation

FIG. 6 is a flowchart showing a procedure of a game process. In the game process, processor 150 first performs an initialization process for clearing the stored content of volatile area R1 (S1). Processor 150 then performs a selection process for having a player select a mode (S2). In the mode selection process, processor 150 controls display unit 120 to display an image for selecting a mode on screen 121, identifies a mode based on data from upper operation unit 141, and writes data indicating the identified mode as selection mode data 167 into volatile area R1. Here, as an example, we assume that a combination of the single stage mode and the 1-player mode is selected, and that data indicating this combination is written into volatile area R1 as selection mode data 167.

Subsequently, processor 150 performs a play process (S3). A period from the start to the end of the play process is a play period. In the play process, processor 150 performs a step sequence display process (S31), a sound replay process (S32), and an evaluation process (S33) in parallel. The play process ends when the sound replay process and the step sequence display process end.

In the step sequence display process, processor 150 uses standard dance data (standard dance data 164) corresponding to the mode (single stage mode) indicated by selection mode data 167, and causes display unit 120 to display the step sequence of a standard dance in a form of display corresponding to the mode (1-player mode) indicated by selection mode data 167. As a result, an image instructing each step of the standard dance, specifically, a moving image in which, as shown in FIGS. 2 and 3, plural marks correlated one-to-many with 4 panels move to reach the base line BL are displayed on screen 121.

In the evaluation process, processor 150 repeatedly performs a process of identifying, based on operation data supplied from lower operation unit 142, a panel that was stepped on in first stage 1421, calculating, in a case in which the panel that was stepped is a panel to be stepped on, the difference in time between a time at which the panel was stepped on and a time at which this panel should be stepped on (a time at which a step panel instruction mark corresponding to this panel reaches base line BL), comparing the difference in time with a predetermined threshold, deciding and displaying the evaluation, and also adding evaluation data 161 showing the evaluation into volatile area R1.

In the sound replay process, processor 150 uses sound data 162 to replay sounds. Specifically, processor 150 supplies sound data 162 to sound emitter 130. As a result, sound emitter 130 uses the supplied sound data 162 to output a sound signal for an R channel to speaker 131, a sound signal for an L channel to speaker 132, the sound signal for the L channel to speaker 133, and the sound signal for the R channel to speaker 134. Thus, sounds corresponding to sound data 162 are output from speakers 131 to 134.

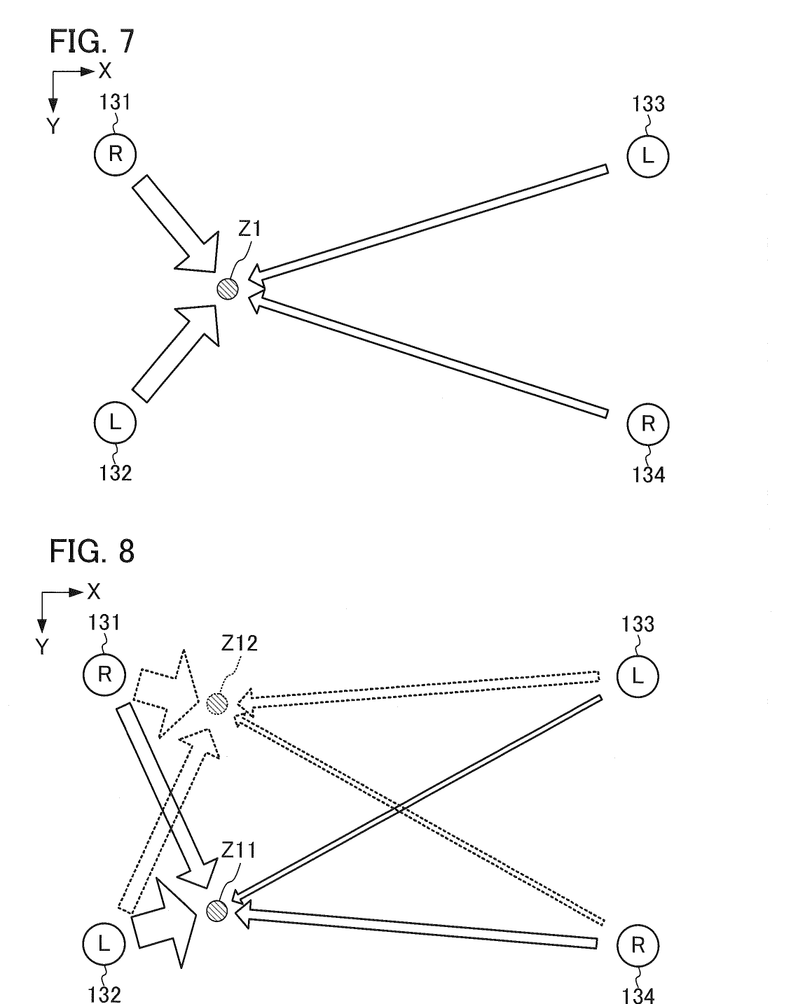

FIG. 7 is a diagram schematically showing how sounds are conveyed to a player from speakers 131 to 134 in a play of the single stage mode with the 1-player mode. As shown in this figure, in the single stage mode with the 1-player mode, the number of players is 1, and the head of the player is often located near a location Z1. Location Z1 is close to speakers 131 and 132 and is distant from speakers 133 and 134. Therefore, from among the sounds output, most of the sounds that reach the player are those output from speakers 131 and 132, and the sound pressure level of an R-channel sound that reaches a player output from speaker 131 and the sound pressure level of an L-channel sound that reaches a player output from speaker 132 are sufficiently high. Therefore, rich sounds will be provided to the player.

FIG. 8 is a diagram schematically showing changes in how the sounds are conveyed from speakers 131 to 134 to a player in a play of the single stage mode and of the 1-player mode. As shown in this figure, in the single stage mode with the 1-player mode, the head of a player may be located near a location Z11 for which the height from the floor surface is small, or may be located near a location Z12 for which the height from the floor surface is large by the player jumping. Locations Z11 and Z12 both are locations near location Z1.

In a case in which the head of a player is located at location Z11, the sound sources listed in descending order according to the sound pressure level of sounds that reach the player are speaker 132(L), speaker 131(R), speaker 134(R), and speaker 133(L). Therefore, also in this case, rich sounds will be provided to the player. On the other hand, in a case in which the head of a player is located at location Z12, the sound sources listed in descending order according to the sound pressure level of sounds that reach the player are speaker 131(R), speaker 132(L), speaker 133(L), and speaker 134(R). Therefore, also in this case, rich sounds will be provided to the player.

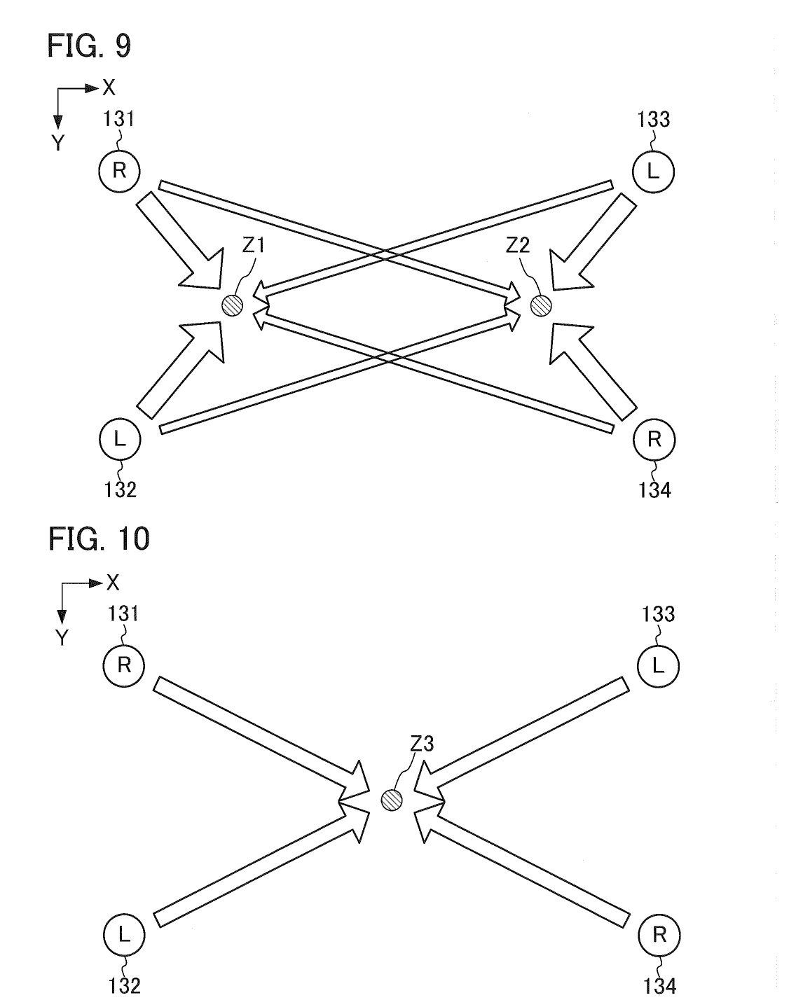

FIG. 9 is a diagram schematically showing how the sounds are conveyed from speakers 131 to 134 to players in a play of the single stage mode and of the 2-player mode. As shown in this figure, the number of players is 2 in the single stage mode with the 2-player mode. The head of a first player would be mostly located near location Z1, and the head of a second player near location Z2. Therefore, for the same reasons as described with respect to FIG. 7, rich sounds will be provided to the first player.

Location Z2 is close to speakers 133 and 134, and is distant from speakers 131 and 132. Therefore, from among the sounds output, most of the sounds that reach the second player are those output from speakers 133 and 134, and the sound pressure level of an L channel-sound that is output from speaker 133 and that reaches the second player and the sound pressure level of an R-channel sound that is output from speaker 134 and that reaches the second player are sufficiently high. Therefore, rich sounds will be provided also to the second player.

In the single stage mode with the 2-player mode, the head of a first player could be located at a location for which the height from the floor surface is small, or could be located near a location Z12 for which the height from the floor surface is large by the player jumping. Either location is a location near location Z1. No matter which location the head of the first player is located at, rich sounds will also be provided to the first player for the same reasons as described with respect to FIG. 8. Similarly, no matter which location near location Z2 the head of the second player is located at, rich sounds will also be provided to the second player.

FIG. 10 is a diagram schematically showing how sounds are conveyed to a player from speakers 131 to 134 in a play of the double stage mode. As shown in this figure, in the double stage mode, the number of players is 1, and the head of the player would be mostly located near location Z3. Location Z3 is a location for which the distance to speaker 131(R) and the distance to speaker 133(L) are approximately the same, and for which the distance to speaker 132(L) and the distance to speaker 134(R) are approximately the same. Therefore, the ratio between L-channel and R-channel components in the sounds output from speaker 131 to 134 and that reach the player will be about 50%. The sound pressure level of L-channel components and the sound pressure level of R-channel components in the sounds will be sufficiently high. Therefore, rich sounds will be provided to the player.

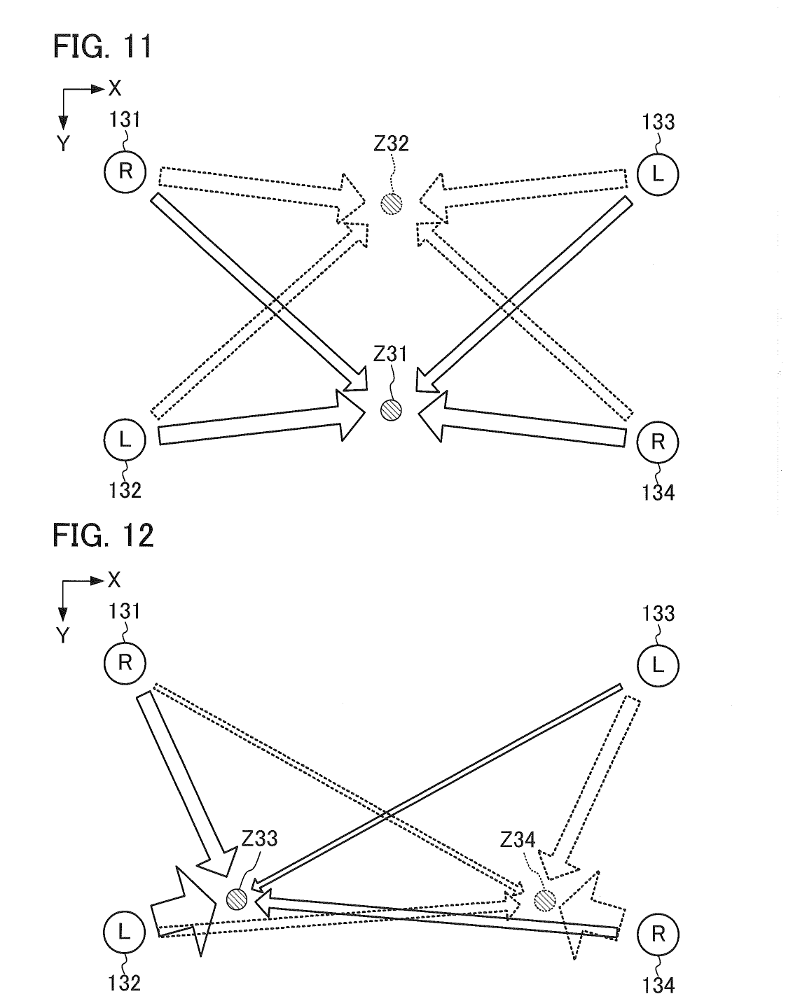

FIGS. 11 and 12 each are diagrams schematically showing changes in how sounds are conveyed from speakers 131 to 134 to a player. FIG. 11 relates to vertical movements of the player, and FIG. 12 relates to transverse movements of the player. As shown in FIG. 11, in the double stage mode, the head of the player could be located near a location Z31 for which the height from the floor surface is small, and could be located near a location Z32 for which the height from the floor surface is large by the player jumping. Locations Z31 and Z32 both are locations near location Z1.

In a case in which the head of the player is located at location Z31, the sound pressure level of sounds from speaker 132(L) and speaker 134(R) will be high, whereas the sound pressure level of sounds from speaker 131(R) and speaker 133(L) will be low. On the other hand, in a case in which the head of the player is located at location Z32, the sound pressure level of sounds from speaker 132(L) and speaker 134(R) will be low, whereas the sound pressure level of sounds from speaker 131(R) and speaker 133(L) will be high. Therefore, in either case, rich sounds will be provided to the player.

In a case in which the head of the player is located at location Z31, most of the L-channel components of sounds that reach the player will be sounds from speaker 132, and most of the R-channel components will be sounds from speaker 134. Also, in a case in which the head of the player is located at location Z32, most of the L-channel components of sounds that reach the player will be sounds from speaker 133, and most of the R-channel components will be those from speaker 131. Therefore, even in a case in which the head of the player is located at location Z31, or is located at location Z32, stereophonic sounds of sufficiently high channel separation will be obtained.

In a case in which the head of the player is located at location Z3 as shown in FIG. 10, the obtained sounds will be monophonic sounds. As described above, stereophonic sounds are preferred to monophonic sounds. However, a problem to be solved by the present invention is that, in the stereo replay, sounds could interfere with the progress of a game (that one or both of L-channel and R-channel sounds cannot be heard well) and is not that monophonic sounds are obtained despite the stereo replay. Even though there is an area in which monophonic sounds are obtained, it is still possible to provide rich sounds, which is an object of the present invention.

In the double stage mode, a player steps on both the panels for first stage 1421 and the panels for second stage 1422. Therefore, as shown in FIG. 12, the head of the player could be located at location Z33, which is the same as location Z11 of FIG. 8, also could be located at location Z34, which is the opposite side of location Z33 in the transverse direction. In a case in which the head of the player is located at location Z33, rich sounds will be provided to the player for the same reasons as described with respect to FIG. 8. Similarly, in a case in which the head of the player is located at location Z34, rich sounds will be provided to the second player.

As has been described in the foregoing, game device 100 can continuously provide rich sounds regardless of the location and posture of a player. It is to be noted that what also contributes to the richness in sounds are the reduced difference between the distance from the head of the player to speaker 131 and the distance to speaker 132 and the reduced difference between the distance from the head of the player to speaker 133 and the distance to speaker 134.

In game device 100, in either direction, L(R)-channel speakers are not sandwiched by R(L)-channel speakers, and there will be no disadvantage that sounds will be cancelled by one another among plural sound image spaces. Therefore, there will be no instances in which the audience around the game device feels a sense of strangeness, and rich sounds will be provided with no interruption even if a player moves in a transverse direction during a play in the double stage mode.

### Modifications

In the above-described embodiment, one of a pair of speakers for which the heights from the floor surface are approximately equal is for an L channel, and the other is for an R channel. However, this may be modified so that speaker 133 (or speaker 132) is for the R channel, and speaker 134 (or speaker 131) is for the L channel. Also according to this mode, rich sounds can be continuously provided regardless of the location and posture of a player. However, in this embodiment, there is a disadvantage, when compared with the above-described embodiment, in that, especially during a player of the double stage mode, only one of L-channel or R-channel sounds could be louder for some players depending on the height of the player.

The above-described embodiment may be modified to employ an embodiment in which the height of speaker 131 from the floor surface and the height of speaker 133 from the floor surface are outside the range of being approximately the same height with each other, an embodiment in which the height of speaker 132 from the floor surface and the height of speaker 134 from the floor surface are outside the range of being approximately the same height with each other, or another embodiment which is a combination of both embodiments. However, such a modification should be limited to an extent that rich sounds can be continuously provided regardless of the posture and location of a player.

In the above embodiment, the display area is configured by one screen, but this may be modified so that the display area is configured by plural screens. For example, a configuration may be employed in which two screens are arranged next to each other in a transverse direction, in which an image for a first player is displayed on the left screen, in which an image for a second player is displayed on the right screen, in which speakers 131 and 132 are arranged in the upper portion of the left periphery of the left screen, and in which speakers 133 and 134 are arranged in the upper portion of the right periphery of the right screen.

In the above embodiment, the Y direction is inclined from the vertical direction. However, the Y direction may correspond to the vertical line if speakers 131 to 134 can be arranged in a lower portion. Also, the above-described embodiment may be modified so that at least one of speakers 131 to 134 may be made of plural speakers. Furthermore, the above embodiment may be modified so that the double stage mode cannot be selected.

The above embodiment may be modified so that types (L or R channel) of or levels (sound pressure level) of sound signals to be supplied to each speaker may be adjusted depending on a selected mode. For example, in a case in which the single stage mode with the 1-player mode is selected, the levels of sound signals for speakers 133 and 134 may be made relatively high.

Although not included in the present invention, a configuration may be employed in which a speaker for the L channel is arranged to the left of the display area, and in which a speaker for the R channel is arranged to the right thereof. In this configuration, in a case in which the single stage mode and the 1-player mode are selected, the level of a sound signal for the L-channel speaker may be made relatively high, and in a case in which the single stage mode and the 2-player mode are selected, a synthesized sound signal of an L-channel sound signal and an R-channel sound signal may be supplied to both speakers. In comparison with this embodiment, the above-described embodiment has an advantage in that the configuration is simple even though the levels of sound signals supplied to two speakers for the same channel are the same.

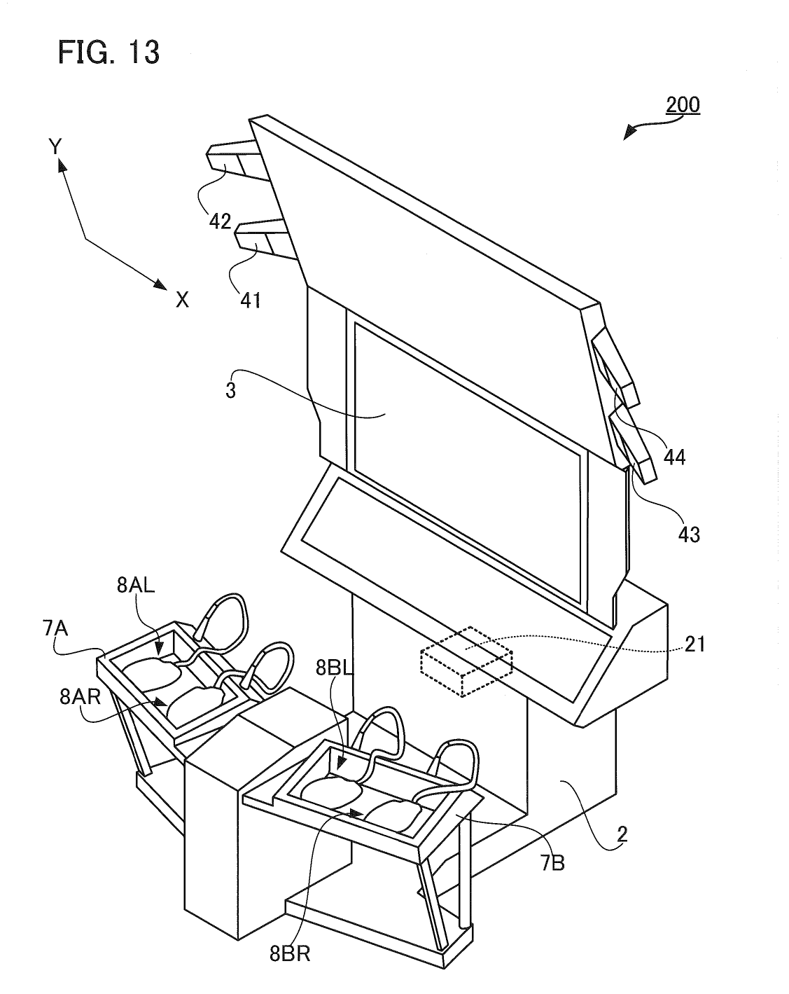

The above-described embodiment may be modified so that it can be applied to a computer game other than a dance game. An example of such a computer game is a gun shooting game in which two players can simultaneously play. FIG. 13 shows an external view of a game device 200 for this gun shooting game.

Game device 200 has a main body 2 having a computer 21, and has plural controllers 8 (8AL, 8AR; 8BL, 8BR) for operating computer 21. Provided on the front side of main body are a rectangular screen (display area) 3 for displaying images, a speaker (first speaker) 41 for an L-channel, a speaker (second speaker) 42 for an R-channel, a speaker (third speaker) 43 for the L-channel, and a speaker (fourth speaker) 44 for the R-channel. In this embodiment, first speaker 41 for the L channel is arranged below second speaker 42 for the R channel, and third speaker 43 for the L channel is arranged below fourth speaker 44 for the R channel.

Two players stand facing screen 3, and perform a play of a gun shooting game by operating controllers 8 while looking at the common image displayed on screen 3 and listening to the sounds output from speakers 41 to 44. Furthermore, provided on main body 2 are a stand 7A for a player A, and a stand 7B for a player B. Controllers 8AL and 8AR held and operated by the first player are rested on stand 7A; and controllers 8BL and 8BR held and operated by the second player are rested on stand 7B. Although not shown, each controller 8 has an operation device to be operated by a player.

1. A game device comprising:
a display unit for displaying an image in a display area;
a first operation device for a first player and a second operation device for a second player, the first operation device and the second operation device being provided in front of the display area and next to each other in a transverse direction;
a first speaker for an R (right) channel and a second speaker for an L (left) channel, the first speaker and the second speaker being provided next to each other in an upper portion of the left periphery of the display area, with one of the speakers being located above the other speaker; and
a third speaker for the L channel and a fourth speaker for the R channel, the third speaker and the fourth speaker being provided next to each other in an upper portion of the right periphery of the display area, with one of the speakers being located above the other speaker.

2. A game device according to claim 1,
wherein a height of the first speaker from a floor surface and a height of the third speaker from the floor surface are approximately the same, and
wherein a height of the second speaker from the floor surface and a height of the fourth speaker from the floor surface are approximately the same.

3. A game device according to claim 1,
wherein a line passing through the first speaker and the second speaker and a line passing through the third speaker and the fourth speaker are inclined so that the distances to a vertical line in front of the display area become smaller as the lines extend upward.

4. A game device according to claim 1,
wherein, in the display area, a first image for the first player and a second image for the second player are displayed next to each other in a transverse direction.

5. A game device according to claim 1,
wherein the first operation device and the second operation device each are operation devices to be stepped on by a foot.
